(19) United States
(12) Patent Application Publication
(10) Pub. No.: US 2017/0087864 A1
(43) Pub. Date: Mar. 30, 2017

(54) PRINTING DEVICE AND INK CIRCULATION CONTROL METHOD

(71) Applicant: FUJIFILM CORPORATION, Tokyo (JP)

(72) Inventors: Toshiyuki AKISHIBA, Kanagawa (JP); Tadashi KYOSO, Kanagawa (JP)

(21) Appl. No.: 15/256,629

(22) Filed: Sep. 5, 2016

(30) Foreign Application Priority Data
Sep. 30, 2015 (JP) 2015-195103

(51) Int. Cl. B41J 2/175

(52) U.S. Cl. CPC B41J 2/17563; B41J 2/17596

(57) ABSTRACT

A printing device includes a jetting section that jets out ink, a storage section that stores the ink, a supply channel through which the ink flows from the storage section toward the jetting section, a recovery channel through which the ink flows from the jetting section toward the storage section, a filter provided on at least one of the supply channel and the recovery channel, a pump provided on at least one of the supply channel and the recovery channel, and a control section. The control section applies control to the pump to make a flow speed of the ink in a non-printing period smaller than a flow speed of the ink in a printing period, the printing period including a period from a printing start time to a printing completion time, and the non-printing period being outside the printing period.

### CROSS-REFERENCE TO RELATED APPLICATIONS

The present application claims priority under 35 U.S.C. §119 to Japanese Patent Application No. 2015-195103, filed Sep. 30, 2015, which is hereby expressly incorporated by reference, in its entirety, into the present application.

### BACKGROUND

Technical Field

The present invention relates to a printing device and an ink circulation control method.

Related Art

The following technology is known as a technology relating to ink circulation control in an inkjet-type printing device. In, for example, Japanese Patent Application Laid-Open (JP-A) No. 2008-254196 (Patent Document 1), an inkjet recording device is recited that is provided with plural droplet jetting elements and with a common flow channel and a common circulation channel that are in fluid communication with the plural droplet jetting elements. Each droplet jetting element includes a nozzle at which droplets are jetted out, a piezoelectric chamber in fluid communication with the nozzle, and a piezoelectric element that displaces a wall face of the piezoelectric chamber. This inkjet recording device is further provided with control means for varying liquid supply amounts supplied to the plural droplet jetting elements through the common flow channel in accordance with liquid jetting amounts that are jetted out from the plural liquid jetting elements, and for controlling liquid circulation amounts circulated in the common circulation channel from the plural droplet jetting elements. When a liquid jetting amount is smaller than a predetermined value, the control means makes a liquid supply amount greater than the liquid jetting amount, and when a liquid jetting amount is greater than the predetermined value, the control means makes the liquid supply amount equal to the liquid jetting amount.

In JP-A No. 2006-168023 (Patent Document 2), an inkjet recording device is recited that includes an inkjet recording head that jets out ink from plural nozzles, a sub-tank that temporarily stores ink to be supplied to the recording head, and ink supply means for supplying ink in the sub-tank to the recording head. The recording head is provided with a common liquid chamber that stores ink to be supplied to a plural number of the nozzles, a first ink inflow port that passes through a first filter at the common liquid chamber, a second ink inflow port that passes through a second filter, and an ink inflow/outflow port that passes through a third filter. In this inkjet recording device, in a printing operation mode that performs printing onto a recording medium, ink is supplied from the sub-tank to the recording head through the first ink inflow port or both the first ink inflow port and the ink inflow/outflow port. On the other hand, in an ink circulation operation mode, ink stored in the sub-tank is supplied through the second ink inflow port to the recording head by the ink supply means, and ink that flows out from the recording head through the ink inflow/outflow port is recovered back into the sub-tank.

Currently, color materials that are used in inkjet-type printing devices mainly employ dyes. Reasons for this include reliable preservation stability and jetting-out stability, according to previous research and results over a long time, and the vividness and transparency of dyes. However, dyes have problems with light durability and water durability. Consequently, there are many cases in which pigment inks are used for applications requiring water durability and light durability. One problem with pigment inks is clogging of inkjet heads. However, there has recently been progress in improving the dispersibility of pigment inks; pigment inks that are currently used in industry have improved relative to heretofore in regard to clogging.

Materials from relatively small molecules such as surfactants to high molecules such as styrene-acryl-based resins are widely used as dispersing agents that are added to pigment inks. The molecule of any dispersing agent, in order to disperse a hydrophobic organic pigment in water, includes a hydrophobic portion for adhering to the pigment and a hydrophilic portion for dispersion in water, and has a carbon chain with a length that exhibits a steric effect sufficient to keep a dispersed state stable.

However, while a pigment ink is circulating through an ink circulation channel of a printing device, soft agglomerations in which the pigment collects together may be formed. This is thought to be because a dispersing agent included in the pigment ink that is circulating through the ink circulation channel is broken up by shear forces applied to the dispersing agent, so the dispersing agent's ability to disperse the pigment deteriorates. If these soft agglomerations of pigment reach the nozzles of an ink jetting head, jetting failures may occur.

The location at which shear forces applied to a dispersing agent in an ink circulation channel are at a maximum is thought to be a filter for removing impurities in the ink. If a mean pore diameter in a filter is h mm and a flow speed of ink circulating in an ink circulation channel is v mm/s, a shear force S applied to a dispersing agent passing through the filter may be expressed by the following expression (1).

S=a×v/h (1)

In this expression, a is a constant.

In order to reduce the shear forces S applied to a dispersing agent contained in an ink circulating through an ink circulation channel, increasing the mean pore diameter h of a filter or reducing the flow speed v of the ink can be considered. However, if the mean pore diameter h of the filter is increased, the impurity removal performance of the filter is reduced. Meanwhile, in order to keep a back pressure at nozzles that are jetting out ink constant during printing processing, while replenishing ink that is consumed by the printing, the flow speed v of the ink must be assured to a certain level.

### SUMMARY

The present invention has been made in consideration of the circumstances described above and an object of the present invention is to provide a printing device and an ink circulation control method that may suppress the formation of soft agglomerations of pigment in ink circulating through a circulation channel.

A printing device according to the present invention includes: a jetting section that jets out ink; a storage section that stores the ink; a supply channel through which the ink flows from the storage section toward the jetting section; a recovery channel through which the ink flows from the jetting section toward the storage section; a filter provided on at least one of the supply channel and the recovery channel; a pump provided on at least one of the supply channel and the recovery channel; and a control section that applies control to the pump to make a flow speed of the ink in a non-printing period smaller than a flow speed of the ink in a printing period, where the printing period includes a period from a printing start time to a printing completion time and the non-printing period is outside the printing period.

An ink circulation control method according to the present invention includes: receiving information relating to printing being performed and not performed; and on the basis of the information, making a flow speed of ink circulating along a circulation channel in a non-printing period smaller than a flow speed of the ink in a printing period, the printing period including a period from a printing start time to a printing completion time, and the non-printing period being outside the printing period.

### BRIEF DESCRIPTION OF THE DRAWINGS

An exemplary embodiment of the present invention will be described in detail based on the following figures, wherein:

FIG. 1 is a sectional diagram showing principal structures of a printing device in accordance with an exemplary embodiment of the present invention.

FIG. 2A is a bottom view showing an example of structure of an ink jetting head in accordance with the exemplary embodiment of the present invention.

FIG. 2B is a magnified view showing a portion of the ink jetting head in accordance with the exemplary embodiment of the present invention.

FIG. 3 is a sectional diagram taken along line 3-3 of FIG. 2B.

FIG. 4 is a diagram showing channels of ink inside the ink jetting head in accordance with the exemplary embodiment of the present invention.

FIG. 5 is a diagram showing structures of an ink circulation system in accordance with the exemplary embodiment of the present invention.

FIG. 6 is a block diagram showing structures of a control system that controls ink circulation in accordance with the exemplary embodiment of the present invention.

FIG. 7 is a flowchart showing a flow of pump control processing by a pump control section in accordance with the exemplary embodiment of the present invention.

FIG. 8 is a graph showing changes over time of a detection signal outputted from a pressure sensor and changes over time of back pressure at a nozzle of the inkjet jetting head in accordance with the exemplary embodiment of the present invention.

FIG. 9 is a graph showing changes over time of a flow speed of ink flowing through a common channel and a recovery channel in accordance with the exemplary embodiment of the present invention.

### DETAILED DESCRIPTION

Below, an example of an embodiment of the present invention is described with reference to the drawings. Structural elements and portions that are the same as one another or equivalent are assigned the same reference symbols in the drawings, and duplicative descriptions are omitted as appropriate.

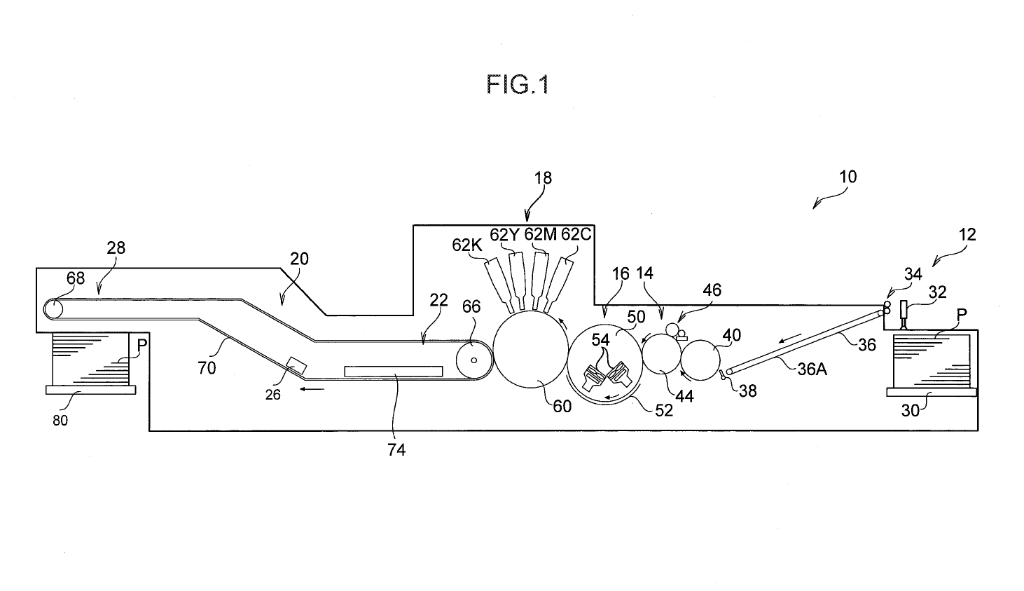

FIG. 1 is a sectional diagram showing principal structures of an inkjet-type printing device 10 according to an exemplary embodiment of the present invention. The printing device 10 is provided with a paper supply section 12 that supplies paper P that is an object for printing, a processing liquid application section 14 that applies a processing liquid to the paper P, and a processing liquid drying section 16 that dries the processing liquid applied to the paper P. The printing device 10 is further provided with an image formation section 18 that forms images on the paper P by jetting out ink droplets at the paper P, and a conveyance section 20 that conveys the paper P on which images have been formed by the image formation section 18 to a paper ejection section 28.

The printing device 10 is still further provided with an ink droplet drying section 22 that dries the ink droplets jetted out to the paper P, a cooling section 26 that cools the paper P, and the paper ejection section 28, which ejects the paper P.

The paper supply section 12 is provided with a paper supply tray 30, a sucker device 32, a paper supply roller pair 34, a feeder board 36, a front lay 38 and a paper supply drum 40. The sucker device 32 picks up paper P stacked on the paper supply tray 30 one sheet at a time, sequentially from the top, and supplies the picked-up paper P to the paper supply roller pair 34 one sheet at a time. The paper supply roller pair 34 is turned by driving force supplied from a motor, which is not shown in the drawings, and conveys the paper P supplied from the sucker device 32 to the feeder board 36.

The feeder board 36 is formed to correspond with a length of the paper P in an orthogonal direction that is orthogonal to the conveyance direction (i.e., a width of the paper P). Belt conveyance mechanisms 36A that extend in the conveyance direction of the paper P are plurally provided at the feeder board 36, spaced apart in the direction orthogonal to the conveyance direction of the paper P. Each belt conveyance mechanism 36A is formed in an endless shape and is turned by driving force supplied from a motor that is not shown in the drawings. The paper P supplied onto the feeder board 36 is conveyed to the front lay 38 by turning of the belt conveyance mechanisms 36A.

The front lay 38 is moved to swing by driving force supplied from a motor that is not shown in the drawings. The front lay 38 corrects a conveyance attitude of paper P that has been conveyed from the feeder board 36 and come into contact with the front lay 38. The paper supply drum 40 is turned by driving force supplied from a motor that is not shown in the drawings and conveys the paper P supplied from the feeder board 36 to the processing liquid application section 14.

The processing liquid application section 14 is provided with a processing liquid application drum 44 and a processing liquid application unit 46. The processing liquid application unit 46 includes a processing liquid application roller that applies the processing liquid and a processing liquid tank in which the processing liquid is stored. The processing liquid application unit 46 is provided to oppose a surface of the processing liquid application drum 44. The processing liquid application unit 46 applies the processing liquid to an image formation surface of paper P that is being conveyed by the processing liquid application drum 44. A strongly acidic liquid that includes a coagulant with the function of causing color materials (pigments) contained in ink droplets jetted out from the image formation section 18 to agglomerate may be employed as the processing liquid. The processing liquid application drum 44 is turned by driving force supplied from a motor, which is not shown in the drawings, and conveys the paper P to which the processing liquid has been applied to the processing liquid drying section 16.

The processing liquid drying section 16 is provided with a processing liquid drying drum 50, a paper conveyance guide 52 and a plural number (two in the present exemplary embodiment) of processing liquid drying units 54. The paper conveyance guide 52 is provided along a conveyance path of the paper P at an outer periphery of the processing liquid drying drum 50. The paper conveyance guide 52 guides conveyance of the paper P along the processing liquid drying drum 50. The processing liquid drying units 54 dry the processing liquid that has been applied to the image formation surface of the paper P being conveyed by the processing liquid drying drum 50, by blowing a drying wind against the image formation surface of the paper P. Thus, a solvent component in the processing liquid is removed and an ink agglomeration film is formed on the image formation surface of the paper P. The processing liquid drying drum 50 is a frame body constructed in a tubular shape. The processing liquid drying drum 50 is turned by driving force supplied from a motor, which is not shown in the drawings, and conveys the paper P that has been subjected to the drying treatment of the processing liquid to the image formation section 18.

The image formation section 18 is provided with an image formation drum 60 and ink jetting heads 62C, 62M, 62Y and 62K. The ink jetting head 62C jets out cyan color ink droplets, the ink jetting head 62M jets out magenta color ink droplets, the ink jetting head 62Y jets out yellow color ink droplets, and the ink jetting head 62K jets out black color ink droplets. The ink jetting heads 62C, 62M, 62Y and 62K oppose an outer periphery face of the image formation drum 60 along a conveyance path of the paper P and are disposed, in this order, to be spaced at constant intervals. The ink jetting heads 62C, 62M, 62Y and 62K each include a line head with a width corresponding to the width of the paper P. Nozzle faces of the line head are disposed to oppose the outer periphery face of the image formation drum 60.

Each of the ink jetting heads 62C, 62M, 62Y and 62K jets out ink droplets of the respective color towards the outer periphery face of the image formation drum 60 from nozzle rows formed in the nozzle face. As a result, an image is formed at the image formation surface of the paper P that is being conveyed by the image formation drum 60. That is, the printing device 10 relating to the present exemplary embodiment is a structure that forms an image by a single pass system in which each line of the image is formed by a single scan. The image formation drum 60 is turned by driving force supplied from a motor, which is not shown in the drawings, and conveys the paper P to which the ink droplets have been applied to the conveyance section 20.

The conveyance section 20 is a conveyance mechanism that is used in common by the ink droplet drying section 22 and the cooling section 26. The conveyance section 20 conveys paper P supplied from the image formation drum 60 to the paper ejection section 28 via the ink droplet drying section 22 and the cooling section 26.

The conveyance section 20 is provided with a first sprocket 66, a second sprocket 68 and an endless-shape chain 70. The chain 70 is wound round the first sprocket 66 and the second sprocket 68. The first sprocket 66, the second sprocket 68 and the chain 70 are provided as respective pairs disposed in correspondence with two ends of the orthogonal direction, which is orthogonal to the conveyance direction, of the paper P. At the pair of chains 70, plural grippers, which are not shown in the drawings, are provided spaced apart at constant intervals in the conveyance direction of the paper P. Leading end portions of the paper P are gripped by the grippers. The first sprockets 66 are turned by driving force supplied from a motor that is not shown in the drawings. The second sprockets 68 and the chains 70 turn in accordance with this turning, conveying the paper P that is gripped by the grippers.

The ink droplet drying section 22 is provided with a drying unit 74. The drying unit 74 dries the ink droplets that have been jetted out onto the image formation surface of the paper P that is being conveyed by the conveyance section 20, by illuminating infrared radiation onto the image formation surface of the paper P.

The cooling section 26 is provided at the downstream side of the ink droplet drying section 22 along the conveyance path of the paper P, at the upstream side of the paper ejection section 28. The cooling section 26 cools the paper P that is being conveyed by the conveyance section 20, by blowing wind onto the image formation surface of the paper P.

The paper P that has gone through the processing by the sections described above is conveyed by the conveyance section 20 to a position corresponding with the paper ejection section 28, and is ejected to a paper ejection tray 80 of the paper ejection section 28.

Below, structures of the ink jetting heads 62C, 62M, 62Y and 62K are described. In the following descriptions, where the ink jetting heads 62C, 62M, 62Y and 62K are being referred to in general without being distinguished, the term “ink jetting head 62” is used.

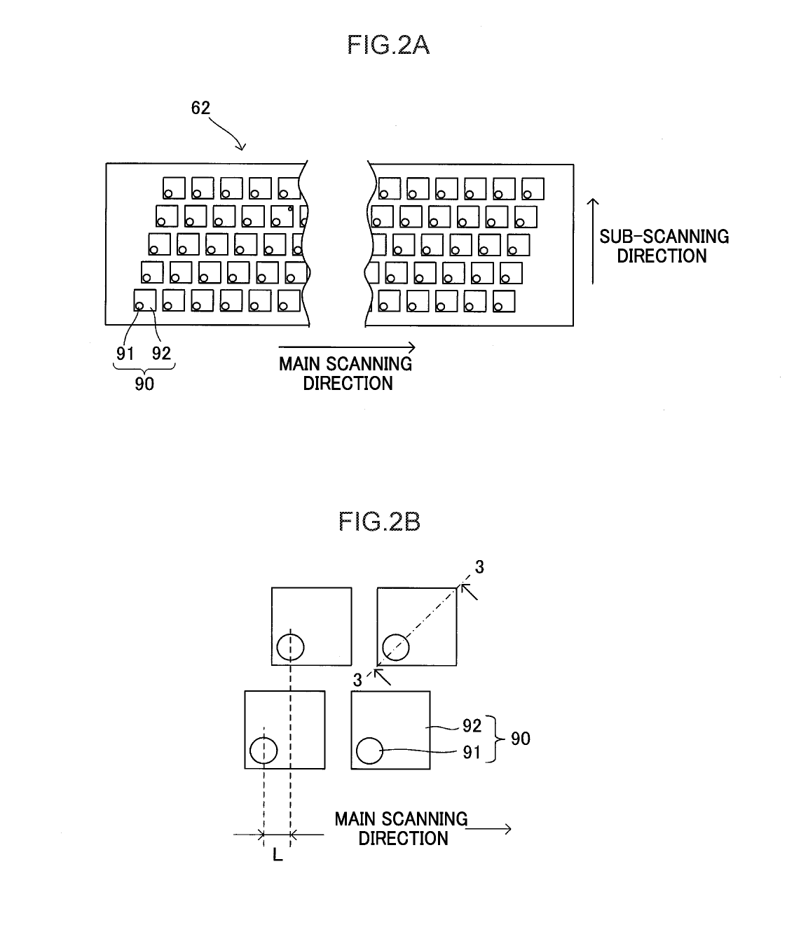

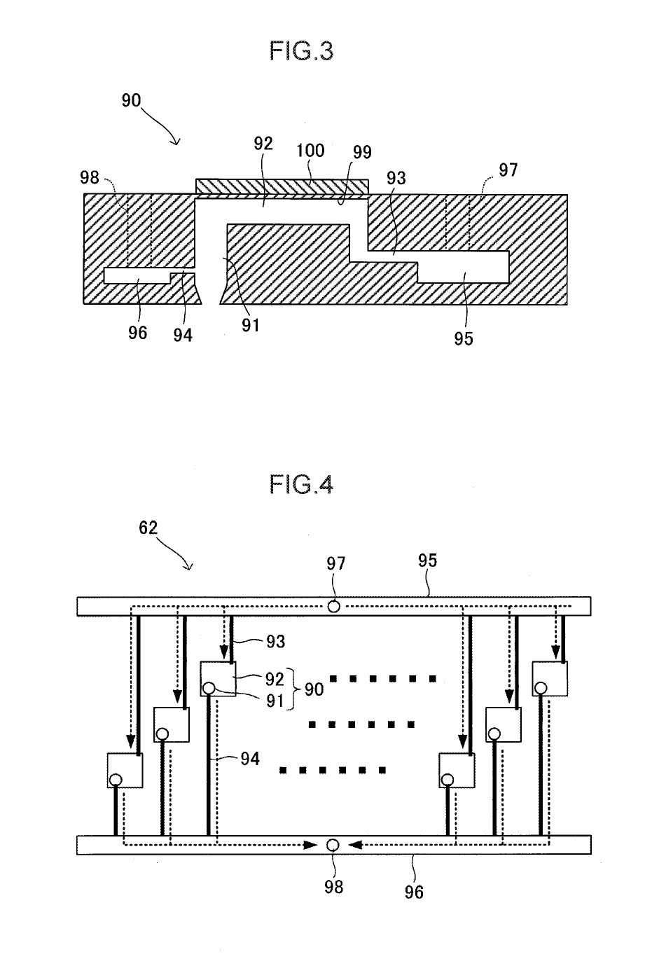

FIG. 2A is a bottom view showing an example of structures of the ink jetting head 62, and FIG. 2B is a magnified view of a portion of the ink jetting head 62. FIG. 3 is a sectional diagram taken along line 3-3 of FIG. 2B. FIG. 4 is a diagram showing channels of ink inside the ink jetting head 62.

The ink jetting head 62 includes plural ink jetting elements 90 arrayed along the conveyance direction of the paper P (a sub-scanning direction) and a main scanning direction that is orthogonal to the sub-scanning direction. Each ink jetting element 90 includes a nozzle 91 from which ink droplets are jetted out and a pressure chamber 92 that is in fluid communication with the nozzle 91. The ink jetting elements 90 in each row arranged in the main scanning direction are disposed at positions that are offset by a constant distance L in the main scanning direction relative to the ink jetting elements 90 in another row that is adjacent. Because the ink jetting elements 90 are arranged in this manner, a pitch of the nozzles 91 in the main scanning direction may be made smaller than the size of the ink jetting elements 90. Thus, the density of dots in an image formed on the paper P may be raised.

As shown in FIG. 4, the respective pressure chambers 92 are in fluid communication with a supply-side common channel 95 via supply-side individual channels 93. The nozzles 91 that are in fluid communication with the pressure chambers 92 are also in fluid communication with a recovery-side common channel 96 via recovery-side individual channels 94. An inflow port 97 and an outflow port 98 are provided at the ink jetting head 62. The inflow port 97 is in fluid communication with the supply-side common channel 95, and the outflow port 98 is in fluid communication with the recovery-side common channel 96. A portion of ink that flows in at the inflow port 97 from outside the ink jetting head 62 passes through the supply-side common channel 95, the supply-side individual channels 93 and the pressure chambers 92 and is jetted out from the nozzles 91. The rest of the ink, which is not jetted out from the nozzles 91, passes through the recovery-side individual channels 94 and the recovery-side common channel 96 and is discharged outside the ink jetting head 62 through the outflow port 98.

As shown in FIG. 3, a diaphragm 99 bounds each pressure chamber 92, and a piezoelectric element 100 is joined to an upper face of the diaphragm 99. When a driving voltage is applied to the piezoelectric element 100, the piezoelectric element 100 deforms, raising pressure in the pressure chamber 92, and an ink droplet is jetted out from the nozzle 91. When the ink droplet is jetted out from the nozzle 91, new ink is supplied to the pressure chamber 92 through the supply-side individual channel 93 from the supply-side common channel 95.

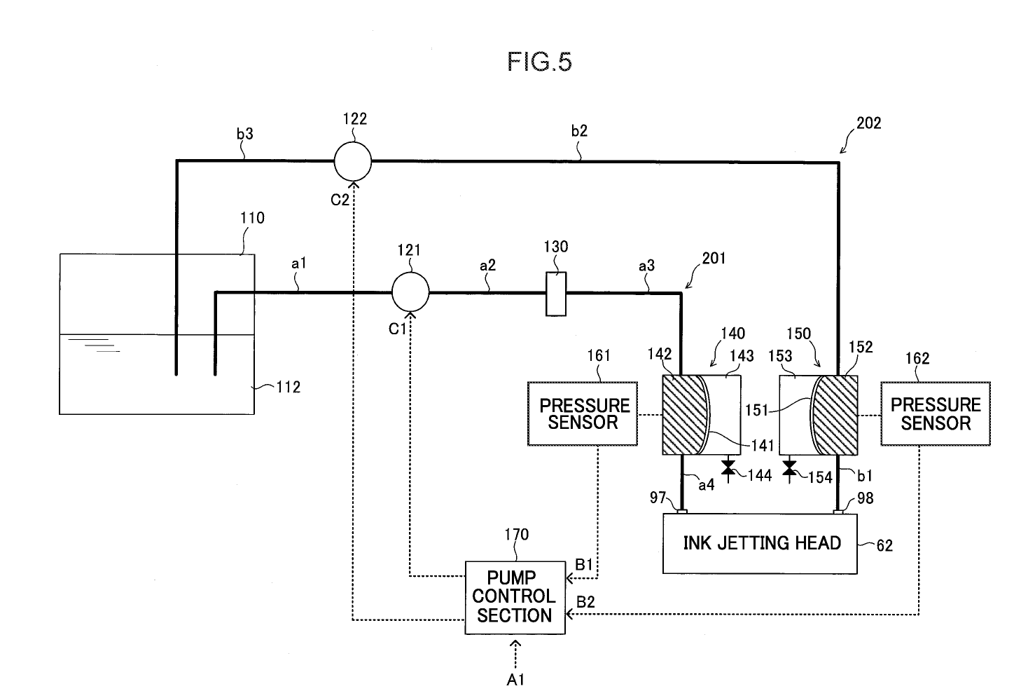

Below, an ink circulation system of the printing device 10 is described. FIG. 5 is a diagram showing an example of structures of the ink circulation system with which the printing device 10 is provided. The ink circulation system shown in FIG. 5 is provided separately for each color of ink.

The ink circulation system is a system for circulating ink 112 between an ink tank 110 and the ink jetting head 62. The ink circulation system includes, in addition to the ink tank 110 and the ink jetting head 62, pumps 121 and 122, a filter 130, a supply-side buffer tank 140, a recovery-side buffer tank 150, pressure sensors 161 and 162, a pump control section 170, and pipes a1 to a4 and b1 to b3.

The ink tank 110 is a container for storing the ink 112. The interior of the ink tank 110 is open to the atmosphere. The ink 112 stored in the ink tank 110 is supplied to the ink jetting head 62 via the pipes a1, a2, a3 and a4, which structure a common channel 201. The ink jetting head 62 is connected to the common channel 201 by the inflow port 97 being connected to one end of the pipe a4. Of the ink 112 that is supplied to the ink jetting head 62, the ink 112 that is not jetted out from the ink jetting head 62 is recovered to the ink tank 110 via the pipes b1, b2 and b3, which structure a recovery channel 202. The ink jetting head 62 is connected to the recovery channel 202 by the outflow port 98 being connected to one end of the pipe b1.

The filter 130 is disposed on the common channel 201 between the pump 121 and the supply-side buffer tank 140. The filter 130 contains a non-woven fabric with a porous structure whose principal material is fibrous polypropylene. The filter 130 extracts impurities included in the ink 112 that is flowing from the ink tank 110 toward the ink jetting head 62.

The supply-side buffer tank 140 is disposed on the common channel 201 between the filter 130 and the ink jetting head 62. The interior of the supply-side buffer tank 140 is partitioned into a liquid chamber 142 and a gas chamber 143 by a partition wall 141 that is constituted of a flexible material such as rubber or the like. The pipes a3 and a4 structuring the common channel 201 are in fluid communication with the liquid chamber 142 of the supply-side buffer tank 140. That is, the ink 112 flowing from the ink tank 110 toward the ink jetting head 62 passes through the liquid chamber 142. A gas such as air or the like is sealed into the gas chamber 143. A release valve 144 for opening the interior of the gas chamber 143 to the atmosphere is provided at the gas chamber 143. According to the structure of the supply-side buffer tank 140 described above, sudden pressure changes in the common channel 201 are moderated by appropriate resilience forces governed by compressibilities of the partition wall 141 and the air sealed in the gas chamber 143.

The pressure sensor 161 detects pressures inside the liquid chamber 142 of the supply-side buffer tank 140, and outputs detection signals B1 representing detected magnitudes of pressure. The detection signals B1 are provided to the pump control section 170.

The recovery-side buffer tank 150 is disposed on the recovery channel 202 between the ink jetting head 62 and the pump 122. The recovery-side buffer tank 150 has a similar structure to the supply-side buffer tank 140. That is, the interior of the recovery-side buffer tank 150 is partitioned into a liquid chamber 152 and a gas chamber 153 by a partition wall 151 that is constituted of a flexible material such as rubber or the like. The pipes b1 and b2 structuring the recovery channel 202 are in fluid communication with the liquid chamber 152 of the recovery-side buffer tank 150. That is, the ink 112 flowing from the ink jetting head 62 toward the ink tank 110 passes through the liquid chamber 152. A gas such as air or the like is sealed into the gas chamber 153. A release valve 154 for opening the interior of the gas chamber 153 to the atmosphere is provided at the gas chamber 153. According to the structure of the recovery-side buffer tank 150 described above, sudden pressure changes in the recovery channel 202 are moderated by appropriate resilience forces governed by compressibilities of the partition wall 151 and the air sealed in the gas chamber 153.

The pressure sensor 162 detects pressures inside the liquid chamber 152 of the recovery-side buffer tank 150, and outputs detection signals B2 representing detected magnitudes of pressure. The detection signals B2 are provided to the pump control section 170.

The pump 121 is disposed on the common channel 201 between the filter 130 and the ink tank 110. A rotation speed per unit time of the pump 121 (below referred to simply as the “rotation speed”) is controlled by control signals C1 provided from the pump control section 170. The pump 122 is disposed on the recovery channel 202 between the recovery-side buffer tank 150 and the ink tank 110. A rotation speed of the pump 122 is controlled by control signals C2 provided from the pump control section 170.

The pump control section 170 controls the rotation speeds of the pumps 121 and 122 on the basis of the respective detection signals B1 and B2 outputted from the pressure sensors 161 and 162. The pump control section 170 also varies the rotation speeds of the pumps 121 and 122 on the basis of information relating to when printing is being performed or not performed, represented by control signals A1 that are provided from a system control section 200, which is described below. By the driving of the pumps 121 and 122, a circulation flow is produced that passes the ink 112 through the ink tank 110, the common channel 201, the ink jetting head 62 and the recovery channel 202, and returns the ink 112 to the ink tank 110.

Below, a composition example of the ink 112 is given.

—Preparation of a Polymer Dispersing Agent P-1—

In a 1000-mL three-necked flask equipped with a mixer and a cooling pipe, 88 g of methyl ethyl ketone was added and heated to 72° C. in a nitrogen atmosphere. A solution in which 0.85 g of dimethyl 2-2′-azobis isobutyrate, 60 g of benzyl methacrylate, 10 g of methacrylic acid and 30 g of methyl methacrylate had been dissolved in 50 g of methyl ethyl ketone was dropped into the flask over three hours. After the dropping was completed and a subsequent reaction time of one hour, a solution in which 0.42 g of dimethyl 2-2′-azobis isobutyrate had been dissolved in 2 g of methyl ethyl ketone was added, the temperature was raised to 78° C., and heating at 78° C. was continued for four hours. A reaction solution that was obtained was re-precipitated twice in a very large quantity of hexane. An educed resin was dried to provide 96 g of a polymer dispersing agent P-1.

The composition of the obtained resin was verified by nuclear magnetic resonance (1H-NMR), and the mean molecular weight (Mw) was found by gel permeation chromatography (GPC) to be 44,600. The acid value of the polymer was calculated by a method described in Japanese Industrial Standards (JIS K0070:1992) and found to be 65.2 mg KOH/g.

—Preparation of a Cyan Dispersion—

Ten parts of pigment blue 15:3 (PHTHALOCYANINE BLUE A220, fabricated by Dainichiseika Color & Chemicals Mfg. Co., Ltd.), 5 parts of the polymer dispersing agent P-1 obtained as described above, 42 parts of methyl ethyl ketone, 5.5 parts of a 1 mol/L hydrous solution of NaOH, and 87.2 parts of deionized water were mixed together and dispersed for 2 to 6 hours in a bead mill using 0.1 mm diameter zirconia beads.

Methyl ethyl ketone was removed from the obtained dispersion at 55° C. under low pressure, and some of the water was removed. Thus, a cyan dispersion with a pigment concentration of 10.2% by weight was obtained.

The cyan dispersion was prepared as described above to serve as a color material. Using the color material (cyan dispersion) obtained as described above, the following components were mixed together to form an ink composition and prepare the ink 112.

—Ink Composition Example—

| | |
|---|---|
| Cyan pigment (pigment blue 15:3): | 4% |
| Polymer dispersing agent (described above, P-1): | 2% |
| Trioxypropylene glyceryl ether (SANNONIC GP-250, | 15% |
| fabricated by Sanyo Chemical Industries, Ltd.): | |
| OLFINE E1010 (surfactant, fabricated by | 1% |
| Nisshin Chemical Co., Ltd.): | |
| Deionized water: | 78% |

Note that the composition of the liquid given above is an example and may be modified as appropriate.

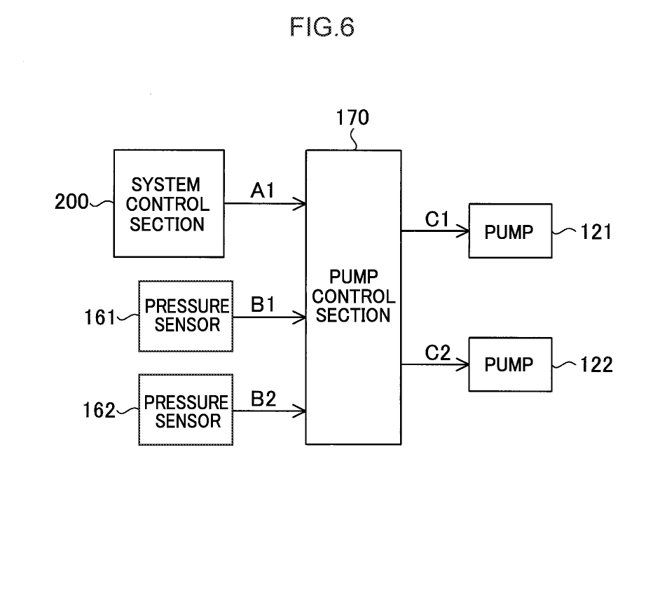

FIG. 6 is a block diagram showing structures of a control system that controls ink circulation in the ink circulation system described above. The control system that controls the ink circulation includes, in addition to the pressure sensors 161 and 162, pumps 121 and 122, and pump control section 170 described above, the system control section 200.

The printing device 10 is connected to a personal computer, which is not shown in the drawings, via the Internet. Printing workflow management software is installed at the computer. When a print job is registered by the printing workflow management software, the printing workflow management software sends a command (below referred to as a “print command”) to the system control section 200 of the printing device 10 commanding that printing be executed on the basis of processing conditions of the registered print job.

The system control section 200 is structured with a central processing unit and peripheral circuits. The system control section 200 performs general control of printing processing at the printing device 10. When the system control section 200 receives a print command from the printing workflow management software, the system control section 200 provides control signals A1 indicating that printing is being performed to the pump control section 170. In contrast, before the system control section 200 receives a print command from the printing workflow management software, and after printing relating to a print command received from the printing workflow management software has been completed, the system control section 200 provides control signals A1 to the pump control section 170 indicating that printing is not being performed. The pump control section 170 controls the pumps 121 and 122 as described below on the basis of the control signals A1 provided from the system control section 200 and the respective detection signals B1 and B2 provided from the pressure sensors 161 and 162.

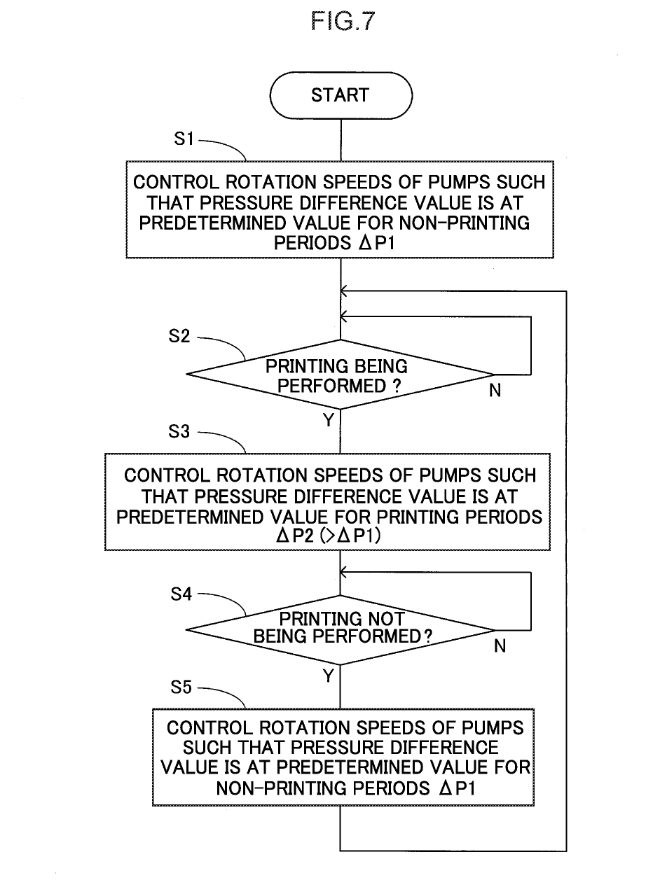

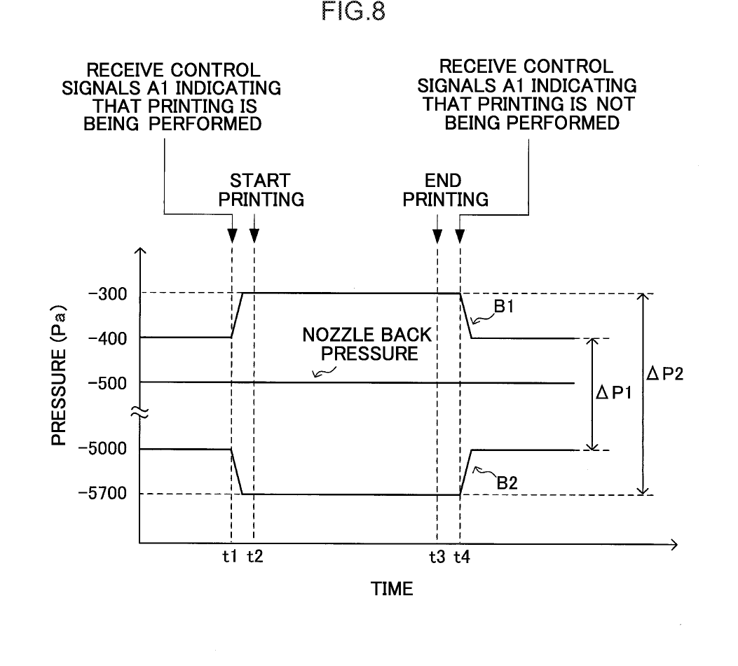

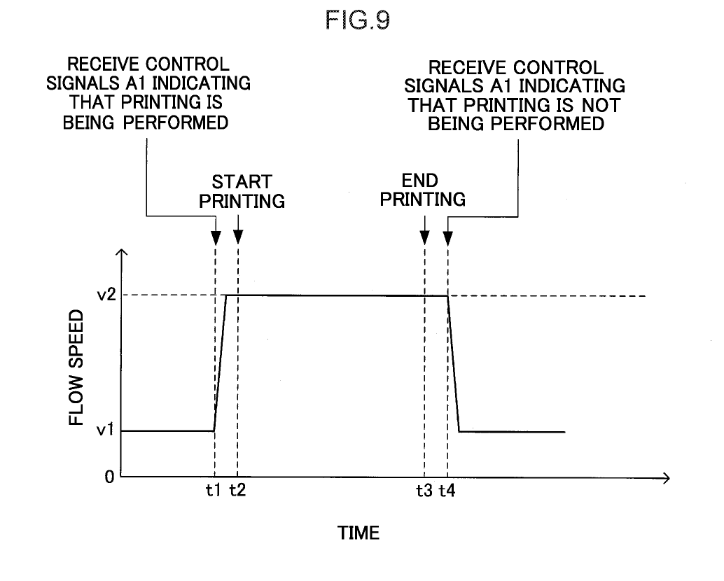

FIG. 7 is a flowchart showing an example of a flow of pump control processing by the pump control section 170. FIG. 8 is a graph showing an example of changes over time of pressure in the liquid chamber 142 of the supply-side buffer tank 140 (that is, changes over time of the detection signals B1 outputted from the pressure sensor 161), changes over time of pressure in the liquid chamber 152 of the recovery-side buffer tank 150 (that is, changes over time of the detection signals B2 outputted from the pressure sensor 162), and changes over time of back pressure at the nozzles 91 of the ink jetting head 62. The pressure values shown in FIG. 8 represent relative pressures compared to atmospheric pressure. FIG. 9 is a graph showing changes over time of a flow speed (a flow amount per unit area) of the ink 112 flowing through the common channel 201 and the recovery channel 202.

In a period before a print command is received from the printing workflow management software, the system control section 200 provides control signals A1 indicating that printing is not being performed to the pump control section 170. In step S1, when the pump control section 170 receives the control signals A1 indicating that printing is not being performed, the pump control section 170 provides respective control signals C1 and C2 to the pumps 121 and 122. As a result, the rotation speeds of the pumps 121 and 122 are controlled such that pressure in the liquid chamber 142 of the supply-side buffer tank 140 (a pressure value represented by the detection signals B1) goes to a target value for non-printing periods (for example, around −400 Pa) and pressure in the liquid chamber 152 of the recovery-side buffer tank 150 (a pressure value represented by the detection signals B2) goes to a target value for non-printing periods (for example, around −5000 Pa). That is, the pump control section 170 controls the rotation speeds of the pumps 121 and 122 such that a difference between a pressure in the common channel 201 close to the ink jetting head 62 and a pressure in the recovery channel 202 close to the ink jetting head 62 (below referred to as “the pressure difference value”) goes to a predetermined value for non-printing periods ΔP1 (see FIG. 8). A back pressure at the nozzles 91 of the ink jetting head 62 is controlled to a predetermined value (for example, −500 Pa) by the pressures of the liquid chambers 142 and 152 being controlled as described above. Here, the pump control section 170 may control the rotation speeds of the pumps 121 and 122 by proportional-integral-derivative (PID) control using the respective detection signals B1 and B2 outputted from the pressure sensors 161 and 162. A circulation flow of the ink 112 is produced in the circulation path including the common channel 201 and the recovery channel 202 by the driving of the pumps 121 and 122. Moreover, by the pressure difference value being controlled to the value ΔP1, the flow speed of the ink 112 flowing through the common channel 201 and the recovery channel 202 is controlled to a flow speed for non-printing periods v1 (see FIG. 9).

In step S2, the pump control section 170 makes a determination as to whether control signals A1 that indicate that printing is being performed have been received from the system control section 200. When the system control section 200 receives a print command from the printing workflow management software, the system control section 200 provides the control signals A1 that indicate that printing is being performed to the pump control section 170. When the pump control section 170 receives the control signals A1 that indicate that printing is being performed from the system control section 200, the processing advances to step S3.

In step S3, the pump control section 170 controls the rotation speeds of the pumps 121 and 122 with the control signals C1 and C2 such that the pressure in the liquid chamber 142 of the supply-side buffer tank 140 (the pressure value represented by the detection signals B1) goes to a target value for printing periods (for example, around −300 Pa) and the pressure in the liquid chamber 152 of the recovery-side buffer tank 150 (the pressure value represented by the detection signals B2) goes to a target value for printing periods (for example, around −5700 Pa). That is, the pump control section 170 controls the rotation speeds of the pumps 121 and 122 such that the pressure difference value goes to a predetermined value for printing periods ΔP2 (>ΔP1) (see FIG. 8). By the pressures of the liquid chambers 142 and 152 being controlled as described above, the back pressure at the nozzles 91 of the ink jetting head 62 is maintained at the same value as the predetermined value in the non-printing period (in this example, −500 Pa). Because the pressure difference value in the printing period (ΔP2) is larger than the pressure difference value in the non-printing period (ΔP1), the flow speed of the ink 112 flowing through the common channel 201 and the recovery channel 202 is controlled to a flow speed v2 that is larger than the flow speed v1 for non-printing periods (see FIG. 9).

In FIG. 8, a situation is shown in which the control signals A1 indicating that printing is being performed are received from the system control section 200 at time t1, and the pressure difference value switches from the value for non-printing periods ΔP1 to the value for printing periods ΔP2. After the pressure difference value has switched to the value for printing periods ΔP2, printing starts at time t2. That is, time t2 represents a printing start time of the printing device 10, and the transition of the pressure difference value from ΔP1 to ΔP2 is completed before the printing start time, time t2.

In FIG. 9, a situation is shown in which the control signals A1 indicating that printing is being performed are received from the system control section 200 at time t1, and the flow speed of the ink 112 flowing through the common channel 201 and the recovery channel 202 switches from the flow speed for non-printing periods v1 to the flow speed for printing periods v2 (>v1). After the flow speed of the ink 112 flowing through the common channel 201 and the recovery channel 202 has switched to the flow speed for printing periods v2, the printing starts at time t2. That is, the transition of the flow speed of the ink 112 from v1 to v2 is completed before the printing start time, time t2.

In step S4, the pump control section 170 makes a determination as to whether control signals A1 that indicate that printing is not being performed have been received from the system control section 200. When the printing relating to the print command received from the printing workflow management software is completed, the system control section 200 provides the control signals A1 that indicate that printing is not being performed to the pump control section 170. When the pump control section 170 receives the control signals A1 that indicate that printing is not being performed from the system control section 200, the processing advances to step S5.

In step S5, the pump control section 170 controls the rotation speeds of the pumps 121 and 122 with the control signals C1 and C2 such that the pressure in the liquid chamber 142 of the supply-side buffer tank 140 (the pressure value represented by the detection signals B1) goes to the target value for non-printing periods (in this example, around −400 Pa) and the pressure in the liquid chamber 152 of the recovery-side buffer tank 150 (the pressure value represented by the detection signals B2) goes to the target value for non-printing periods (in this example, around −5000 Pa). That is, the pump control section 170 controls the rotation speeds of the pumps 121 and 122 such that the pressure difference value goes to the predetermined value for non-printing periods ΔP1 (<ΔP2) (see FIG. 8). By the pressures of the liquid chambers 142 and 152 being controlled as described above, the back pressure at the nozzles 91 of the ink jetting head 62 is maintained at the same value as the predetermined value in the printing period (in this example, −500 Pa). Because the pressure difference value in the printing period (ΔP2) is smaller than the pressure difference value in the non-printing period (ΔP1), the flow speed of the ink 112 flowing through the common channel 201 and the recovery channel 202 is controlled to the flow speed v1 that is smaller than the flow speed v2 for printing periods 2 (see FIG. 9).

In FIG. 8, a situation is shown in which the printing finishes at time t3, control signals A1 indicating that the printing has finished are received from the system control section 200 at time t4, and the pressure difference value switches from the value for printing periods ΔP2 to the value for non-printing periods ΔP1. That is, time t3 represents a printing completion time of the printing device 10, and the transition of the pressure difference value from ΔP2 to ΔP1 starts after the printing completion time, time t3. In FIG. 8, a situation is shown in which the back pressure of the nozzles 91 makes a constant transition between the printing period and the non-printing period. Because of this control to keep the back pressure of the nozzles 91 constant, meniscus states of the ink 112 in the nozzles 91 may be kept constant over non-printing periods and printing periods.

In FIG. 9, a situation is shown in which the printing finishes at time t3 and, at time t4, the control signals A1 indicating that the printing has finished are received from the system control section 200 and the flow speed of the ink flowing through the common channel 201 and the recovery channel 202 switches from the flow speed v2 for printing periods to the flow speed v1 for non-printing periods. That is, the transition of the flow speed of the ink 112 from v2 to v1 starts after the printing completion time, time t3.

Between the printing start time t2 and the printing completion time t3, printing is performed on one sheet or two or more sheets of the paper P. When the pump control section 170 completes the processing of step S5, the processing returns to step S2.

According to the printing device 10 relating to the present exemplary embodiment, when the ink 112 circulating along the circulation path that includes the common channel 201 and the recovery channel 202 passes through the filter 130, it is expected that shear forces will be applied to a dispersing agent contained in the ink 112.

In this exemplary embodiment, a production amount M of agglomeration bodies of pigment in the ink 112 may be expressed by the following expression (2).

M=b×v(t)^{α} (2)

In this expression, the term v(t) represents the flow speed of the ink 112 with time t as a variable, and b and a represent constants. The value of a is between 2 and 3. That is, the production amount M of agglomeration bodies of the pigment increases greatly as the flow speed of the ink 112 passing through the common channel 201 and the recovery channel 202 increases, and also increases with the passage of time.

According to the printing device 10 relating to the present exemplary embodiment, the flow speed of the ink 112 is set to v2 in a printing period, including a period from the printing start time at time t2 to the printing completion time at time t3. In non-printing periods, including a period before the time t1 at which the control signals A1 indicating that printing is being performed are received from the system control section 200 and a period after the time t4 at which the control signals A1 indicating that printing is not being performed are received from the system control section 200, the flow speed of the ink 112 is set to the flow speed v1 that is smaller than the flow speed v2 for printing periods.

Thus, because the flow speed v1 of the ink 112 in non-printing periods is smaller than the flow speed v2 in printing periods, a time-integrated value of shear forces applied to the dispersing agent contained in the ink 112 may be made smaller than in a case in which the flow speed of the ink 112 is fixed at the flow speed v2. As a result, a production amount of agglomeration bodies of the pigment in the ink 112 may be suppressed, and the probability of occurrences of jetting failures may be reduced. For example, a circulation amount of the ink 112 is reduced by making the flow speed v1 for non-printing periods smaller than the flow speed v2 for printing periods. Thus, by a circulation amount of the ink 112 being reduced to about half the amount in a case which the flow speed of the ink 112 is fixed at the flow speed v2, the production amount M of agglomeration bodies of the pigment may be suppressed to between 1/9 and ¼ of the amount in the case in which the flow speed of the ink 112 is fixed at the flow speed v2.

To suppress the production amount of agglomeration bodies of the pigment, setting the flow speed of the ink 112 to zero in non-printing periods can be considered. However, with a view to suppressing thickening of the ink due to evaporation of the ink from the distal ends of the nozzles 91 and to always keeping the back pressure of the nozzles 91 constant, it is preferable to maintain the flow speed of the ink 112 in non-printing periods at a value greater than zero. That is, it is preferable for the pump control section 170 to control the pumps 121 and 122 such that the ink 112 flows through the common channel 201 and recovery channel 202 even in non-printing periods.

Further, in order to suppress the production amount of agglomeration bodies of the pigment, making the flow speed of the ink 112 in printing periods the same as the flow speed of the ink 112 in non-printing periods can be considered, that is, making the flow speed of the ink 112 in printing periods significantly smaller. However, a flow speed of a certain magnitude is necessary in printing periods in order to promote the exclusion of bubbles in the ink that are caused by jetting failures. Moreover, the flow speed must be larger than the flow speed in non-printing periods in order to suppress thickening of the ink 112 near the nozzles 91 that is caused by evaporation of an aqueous component from the nozzles 91. In the printing device 10 relating to the present exemplary embodiment, the flow speed of the ink 112 in printing periods is controlled to be great enough to promote the exclusion of bubbles in the ink and to suppress thickening of the ink 112.

On the other hand, in non-printing periods, the suppression of thickening of the ink may be moderated. Therefore, the flow speed may be set to be smaller than the flow speed in printing periods. Furthermore, because the transition to the flow speed for a printing period v2 is completed before the time t2 at which printing actually starts, bubbles in the ink may be excluded at the printing start time. Consequently, jetting failures due to bubbles in the ink may be avoided.

In the printing device 10 relating to the present exemplary embodiment, the back pressure of the nozzles 91 is controlled to be constant over printing periods and non-printing periods. This back pressure control of the nozzles 91 is implemented by controlling pressure in the common channel 201 close to the ink jetting head 62 and pressure in the recovery channel 202 close to the ink jetting head 62 on the basis of the respective detection signals B1 and B2 that are outputted from the pressure sensors 161 and 162. The flow speed control of the ink 112 is also implemented by controlling the pressure in the common channel 201 close to the ink jetting head 62 and the pressure in the recovery channel 202 close to the ink jetting head 62 on the basis of the respective detection signals B1 and B2 that are outputted from the pressure sensors 161 and 162. That is, according to the printing device 10 relating to the present exemplary embodiment, the flow speed control of the ink 112 may be implemented using the pressure sensors 161 and 162 that are already present for implementing back pressure control of the nozzles 91. Thus, an increase in costs associated with the added functionality may be suppressed.

In the present exemplary embodiment, a case is illustrated in which the flow speed control of the ink 112 and the back pressure control of the nozzles 91 are implemented by feedback control using the pressure sensors 161 and 162. However, this mode is not limiting. The flow speed control of the ink 112 and back pressure control of the nozzles 91 may be implemented by feedback control using flow amount sensors. That is, the pump control section 170 may control the flow speed of the ink 112 and the back pressure of the nozzles 91 by controlling the rotation speeds of the pumps 121 and 122 such that output values of the flow amount sensors are at predetermined values. The flow speed control of the ink 112 and back pressure control of the nozzles 91 may also be implemented by combining flow amount sensors and pressure sensors.

In the present exemplary embodiment, a mode is illustrated in which the rotation speeds of the pumps 121 and 122 are controlled on the basis of the respective detection signals B1 and B2 outputted from the pressure sensors 161 and 162. Alternatively, the rotation speeds of the pumps 121 and 122 may be controlled to pre-specified rotation speeds. However, because the rotation speeds of the pumps 121 and 122 are controlled on the basis of the respective detection signals B1 and B2 outputted from the pressure sensors 161 and 162, control to track a target value of back pressure at the nozzles 91 of the ink jetting head 62 is possible. That is, variations in a feed amount of the ink 112 by each revolution of a motor in accordance with changes over time of the pumps 121 and 122, pressure variations associated with jetting from the nozzles 91 of the ink jetting head 62 in a printing period, and the like may be tracked. Thus, it is easy to maintain an appropriate back pressure.

In the present exemplary embodiment, a case is illustrated in which control to reduce the flow speed of the ink in non-printing periods relative to the flow speed of the ink in printing periods is implemented by applying control to the pumps 121 and 122 to make the difference between the pressure in the common channel 201 and the pressure in the recovery channel 202 smaller in non-printing periods than in printing periods. However, this mode is not limiting. That is, control to make the flow speed of the ink in non-printing periods outside printing periods smaller than the flow speed of the ink in printing periods including periods from printing start times to printing completion times may be realized by constricting a path that links a supply channel with a recovery channel, or the like, to increase channel resistance. However, in the case in which the control to reduce the flow speed of the ink in non-printing periods relative to the flow speed of the ink in printing periods is implemented by applying control to the pumps 121 and 122 to make the difference between the pressure in the common channel 201 and the pressure in the recovery channel 202 smaller in non-printing periods than in printing periods, there is no need to add an additional mechanism. Thus, back pressure control may be performed using the pump control section 170 and pumps 121 and 122 that circulate the ink 112 in the ink circulation system.

In the present exemplary embodiment, a structure is illustrated in which the filter 130 is disposed on the common channel 201 between the pump 121 and the supply-side buffer tank 140. However, the position of the filter 130 may be modified as appropriate. For example, the filter 130 may be disposed on the recovery channel 202. Further in the present exemplary embodiment, a case is illustrated in which the pump 121 is disposed between the ink tank 110 and the filter 130 and the pump 122 is disposed between the liquid chamber 152 and the ink tank 110. However, the positions of the pumps 121 and 122 may be modified as appropriate.

In the present exemplary embodiment, a piezo-system printing device is illustrated that uses the piezoelectric elements 100 to jet out ink droplets. However, the present invention is also applicable to a thermal-system printing device that jets out ink droplets by creating bubbles in the ink in the pressure chambers 92 by heating.

In the present exemplary embodiment, a linehead-system printing device is illustrated that includes lineheads with a width corresponding to the width of the paper P, but this mode is not limiting. The present invention is also applicable to a shuttlehead-system printing device that feeds the paper P in conjunction with reciprocating movements of a printing head, which moves in the main scanning direction that is orthogonal to the conveyance direction of the paper P, to form an image over the whole of the paper.

In the present exemplary embodiment, a printing device is illustrated that utilizes four colors of ink. However, pale inks, dark inks and special inks may be added as necessary. For example, structures are possible in which heads are added that jet out light inks such as light cyan, light magenta and the like. The order of arrangement of the heads of the respective colors is not particularly limited.

In the present exemplary embodiment, a case is illustrated in which pigment inks are employed. However, dye inks may be employed.

Herein, the ink jetting head 62 is an example of a jetting section of the present invention, the ink tank 110 is an example of a storage section of the present invention, the common channel 201 is an example of a supply channel of the present invention, and the recovery channel 202 is an example of a recovery channel of the present invention. The filter 130 is an example of a filter of the present invention, the pump 121 is an example of a pump of the present invention, and the pump control section 170 is an example of a control section of the present invention. The control signals A1 indicating that printing is being performed and the control signals A1 indicating that printing is not being performed are an example of information indicating when printing is being performed and not performed of the present invention.

In the exemplary embodiment of the present invention, the control section may apply control to the pump to make a difference between a pressure in the supply channel and a pressure in the recovery channel in the non-printing period smaller than the same difference in the printing period.

The control section may receive information relating to printing being performed and not performed and apply control to the pump on the basis of the information.

A printing device according to the present invention may further include a first pressure sensor that outputs first detection signals representing magnitudes of pressure in the supply channel and a second pressure sensor that outputs second detection signals representing magnitudes of pressure in the recovery channel. The control section may apply control to the pump to set a magnitude of pressure represented by the first detection signals and a magnitude of pressure represented by the second detection signals to respective magnitudes that are different from one another in the printing period and the non-printing period.

The control section may apply control to the pump to make the flow speed of the ink in the non-printing period greater than zero.

The control section may apply control to the pump to set the flow speed of the ink in the non-printing period to a first flow speed and, at a time prior to the printing start time, to switch the flow speed of the ink to a second flow speed that is larger than the first flow speed.

The jetting section may include nozzles that jet out the ink. The control section may apply both the control to make the flow speed of the ink in the non-printing period smaller than the flow speed of the ink in the printing period and control to keep a back pressure of the nozzles constant over the printing period and the non-printing period.

According to the present invention, the formation of soft agglomerations of pigment in ink circulating through a circulation channel may be suppressed.

What is claimed is:

1. A printing device comprising:
a jetting section that jets out ink;
a storage section that stores the ink;
a supply channel through which the ink flows from the storage section toward the jetting section;
a recovery channel through which the ink flows from the jetting section toward the storage section;
a filter provided on at least one of the supply channel and the recovery channel;
a pump provided on at least one of the supply channel and the recovery channel; and
a control section that applies control to the pump to make a flow speed of the ink in a non-printing period smaller than a flow speed of the ink in a printing period, where the printing period includes a period from a printing start time to a printing completion time and the non-printing period is outside the printing period.

2. The printing device according to claim 1, wherein the control section applies control to the pump to make a difference between a pressure in the supply channel and a pressure in the recovery channel in the non-printing period smaller than the same difference in the printing period.

3. The printing device according to claim 1, wherein the control section receives information relating to printing being performed and not performed and applies control to the pump on the basis of the information.

4. The printing device according to claim 2, wherein the control section receives information relating to printing being performed and not performed and applies control to the pump on the basis of the information.

5. The printing device according to claim 1, further comprising a first pressure sensor that outputs first detection signals representing magnitudes of pressure in the supply channel and a second pressure sensor that outputs second detection signals representing magnitudes of pressure in the recovery channel,
wherein the control section applies control to the pump to set a magnitude of pressure represented by the first detection signals and a magnitude of pressure represented by the second detection signals to respective magnitudes that are different from one another in the printing period and the non-printing period.

6. The printing device according to claim 2, further comprising a first pressure sensor that outputs first detection signals representing magnitudes of pressure in the supply channel and a second pressure sensor that outputs second detection signals representing magnitudes of pressure in the recovery channel,
wherein the control section applies control to the pump to set a magnitude of pressure represented by the first detection signals and a magnitude of pressure represented by the second detection signals to respective magnitudes that are different from one another in the printing period and the non-printing period.

7. The printing device according to claim 3, further comprising a first pressure sensor that outputs first detection signals representing magnitudes of pressure in the supply channel and a second pressure sensor that outputs second detection signals representing magnitudes of pressure in the recovery channel,
wherein the control section applies control to the pump to set a magnitude of pressure represented by the first detection signals and a magnitude of pressure represented by the second detection signals to respective magnitudes that are different from one another in the printing period and the non-printing period.

8. The printing device according to claim 1, wherein the control section applies control to the pump to make the flow speed of the ink in the non-printing period greater than zero.

9. The printing device according to claim 2, wherein the control section applies control to the pump to make the flow speed of the ink in the non-printing period greater than zero.

10. The printing device according to claim 3, wherein the control section applies control to the pump to make the flow speed of the ink in the non-printing period greater than zero.

11. The printing device according to claim 1, wherein the control section applies control to the pump to set the flow speed of the ink in the non-printing period to a first flow speed and, at a time prior to the printing start time, to switch the flow speed of the ink to a second flow speed that is larger than the first flow speed.

12. The printing device according to claim 2, wherein the control section applies control to the pump to set the flow speed of the ink in the non-printing period to a first flow speed and, at a time prior to the printing start time, to switch the flow speed of the ink to a second flow speed that is larger than the first flow speed.

13. The printing device according to claim 3, wherein the control section applies control to the pump to set the flow speed of the ink in the non-printing period to a first flow speed and, at a time prior to the printing start time, to switch the flow speed of the ink to a second flow speed that is larger than the first flow speed.

14. The printing device according to claim 1, wherein the jetting section comprises nozzles that jet out the ink, and
the control section applies both the control to make the flow speed of the ink in the non-printing period smaller than the flow speed of the ink in the printing period and control to keep a back pressure of the nozzles constant over the printing period and the non-printing period.

15. The printing device according to claim 2, wherein the jetting section comprises nozzles that jet out the ink, and
the control section applies both the control to make the flow speed of the ink in the non-printing period smaller than the flow speed of the ink in the printing period and control to keep a back pressure of the nozzles constant over the printing period and the non-printing period.

16. The printing device according to claim 3, wherein the jetting section comprises nozzles that jet out the ink, and
the control section applies both the control to make the flow speed of the ink in the non-printing period smaller than the flow speed of the ink in the printing period and control to keep a back pressure of the nozzles constant over the printing period and the non-printing period.

17. An ink circulation control method comprising:
receiving information relating to printing being performed and not performed; and
on the basis of the information, making a flow speed of ink circulating along a circulation channel in a non-printing period smaller than a flow speed of the ink in a printing period, where the printing period includes a period from a printing start time to a printing completion time and the non-printing period is outside the printing period.
